(19) United States
(12) Patent Application Publication
(10) Pub. No.: US 2026/0370834 A1
(43) Pub. Date: Nov. 19, 2026

(54) METHOD AND DEVICE FOR VIDEO CODING THAT INTRA-PREDICT CHROMA BLOCK ON BASIS OF GEOMETRIC PARTITIONING

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Dong Gyu Sim, Seoul (KR); Min Hun Lee, Uijeongbu-si (KR); Han Sol Choi, Dongducheon-si (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 19/130,869

(22) PCT Filed: Sep. 6, 2023
(86) PCT No.: PCT/KR2023/013356

§ 371 Date: May 16, 2025

(30) Foreign Application Priority Data
Nov. 21, 2022 (KR) 10-2022-0156673
Sep. 1, 2023 (KR) 10-2023-0116352

(51) Int. Cl. H04N 19/136; H04N 19/159; H04N 19/176; H04N 19/186

(52) U.S. Cl. CPC H04N 19/136; H04N 19/159; H04N 19/176; H04N 19/186

(57) ABSTRACT

A method and a device for video coding intra-predict a chroma block based on geometric partitioning. An image decoding device establishes a corresponding luma region of the current chroma block from a reconstructed region of a luma component. The corresponding luma region is an intra-predicted region and represents a luma block or a luma region co-located with the current chroma block. The image decoding device obtains a prediction mode of the current chroma block based on whether a spatial geometric partitioning mode is applied to the corresponding luma region, an intra-prediction mode of the corresponding luma region, and block partition structures of the luma component and a chroma component. The image decoding device generates a prediction block of the current chroma block based on the prediction mode of the current chroma block.

### CROSS-REFERENCE TO RELATED APPLICATIONS

This is a U.S. national stage of International Application No. PCT/KR2023/013356 filed on Sep. 6, 2023, which claims priority to Korean Patent Application No. 10-2022-0156673 filed on Nov. 21, 2022, and Korean Patent Application No. 10-2023-0116352, filed on Sep. 1, 2023, the entire contents of each of which are incorporated herein by reference.

### TECHNICAL FIELD

The present disclosure relates to a video coding method and an apparatus intra-predicting a chroma block based on geometric partitioning.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

The VVC technique adopts geometric partitioning mode (GPM), an inter-prediction technique, for prediction based on partitioning that is more flexible than square and rectangular partitioning based on Quadtree plus Multiple-Type Tree (QT+MTT) partition structure. GPM performs the prediction of the current block based on the mode index and the motion vector information of the partitioned region. Here, the mode index indicates one of the geometric partitioning modes predefined for partitioning the current block, and the motion vector information may be derived for predicting a subregion from partitioning the current block.

The encoder transmits the mode index and the motion vector information to the decoder. The decoder partitions the current block into two regions according to the parsed geometric partitioning mode. The decoder uses the movement vector information to generate prediction signals for each subregion, and then weight sums the generated prediction signals to generate the final prediction block. At this time, the weights used for weighted summing may be determined based on the geometric partitioning mode, and a blending area may be determined to be a fixed area based on the size of the current block and the geometric partitioning mode.

Meanwhile, a spatial geometric partitioning mode (SGPM) is adapted to be applied to the intra prediction of the current block. The SGPM is an intra-prediction technique that is equally applied to the luma component and the chroma component. Therefore, to increase the video coding efficiency and enhance the video quality, there is a need for a method of efficiently utilizing geometric partitioning in the intra prediction of the chroma block.

### SUMMARY

The present disclosure seeks to provide a video coding method and an apparatus that intra predicts a current chroma block by using geometric partitioning when predicting a chroma component after predicting and reconstructing a luma component for the current block.

At least one aspect of the present disclosure provides a method of reconstructing a current chroma block by a video decoding device. The method includes establishing a corresponding luma region of the current chroma block from a reconstructed region of a luma component. The corresponding luma region is an intra-predicted region and representing a luma block or a luma region co-located with the current chroma block. The method also includes obtaining a prediction mode of the current chroma block based on whether a spatial geometric partitioning mode is applied to the corresponding luma region, an intra-prediction mode of the corresponding luma region, and block partition structures of the luma component and a chroma component. The method also includes generating a prediction block of the current chroma block based on the prediction mode of the current chroma block.

Another aspect of the present disclosure provides a method of encoding a current chroma block by a video encoding device. The method includes establishing a corresponding luma region of the current chroma block from a reconstructed region of a luma component. The corresponding luma region being an intra-predicted region and representing a luma block or a luma region co-located with the current chroma block. The method also includes determining a prediction mode of the current chroma block based on whether a spatial geometric partitioning mode is applied to the corresponding luma region, an intra-prediction mode of the corresponding luma region, and block partition structures of the luma component and a chroma component. The method also includes generating a prediction block of the current chroma block based on the prediction mode of the current chroma block.

Yet another aspect of the present disclosure provides a computer-readable recording medium storing a bitstream generated by a video encoding method. The video encoding method includes establishing a corresponding luma region of a current chroma block from a reconstructed region of a luma component. The corresponding luma region being an intra-predicted region and representing a luma block or a luma region co-located with the current chroma block. The video encoding method also includes determining a prediction mode of the current chroma block based on whether a spatial geometric partitioning mode is applied to the corresponding luma region, an intra-prediction mode of the corresponding luma region, and block partition structures of the luma component and a chroma component. The video encoding method also includes generating a prediction block of the current chroma block based on the prediction mode of the current chroma block.

As described above, the present disclosure provides a video coding method and an apparatus for searching multiple candidate prediction blocks by using template matching and generating a prediction block of the current block from the searched multiple candidate prediction blocks. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a block diagram of a detailed portion of the video decoding device, according to at least one embodiment of the present disclosure.

FIG. 7 is a diagram illustrating a partitioning mode of a corresponding luma block, according to at least one embodiment of the present disclosure.

FIGS. 8A and 8B are diagrams illustrating the determination of a prediction mode of a current chroma block, according to some embodiments of the present disclosure.

FIG. 9 is a diagram illustrating samples of a luma component and a chroma component for deriving an equation used for cross-component-based prediction (CC-based prediction), according to at least one embodiment of the present disclosure.

FIGS. 10A through 10C are diagrams illustrating the determination of a prediction mode of a current chroma block, according to some embodiments of the present disclosure.

FIG. 11 is a diagram illustrating the determination of a prediction mode of a current chroma block, according to at least one embodiment of the present disclosure.

FIG. 12 is a diagram illustrating samples of a luma component and a chroma component for deriving an equation used for CC-based prediction, according to at least one embodiment of the present disclosure.

FIG. 13 is a diagram illustrating the determination of a prediction mode of a current chroma block, according to at least one embodiment of the present disclosure.

FIG. 14 is a diagram illustrating samples of a luma component and a chroma component for deriving an equation used for CC-based prediction, according to at least one embodiment of the present disclosure.

FIG. 15 is a diagram illustrating multiple predefined downsampling filters according to at least one embodiment of the present disclosure.

FIG. 16 is a flowchart of a method of predicting a current chroma block by the video encoding device, according to at least one embodiment of the present disclosure.

FIG. 17 is a flowchart of a method of predicting a current chroma block by the video decoding device, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

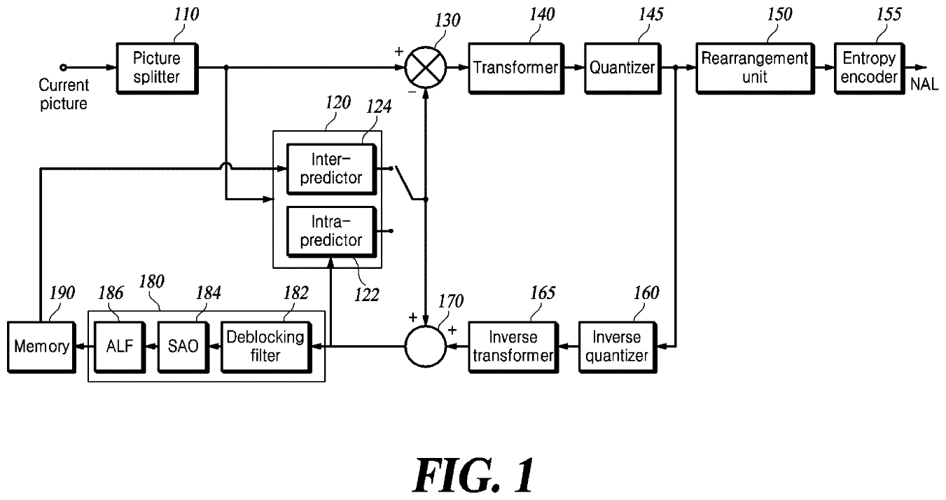

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

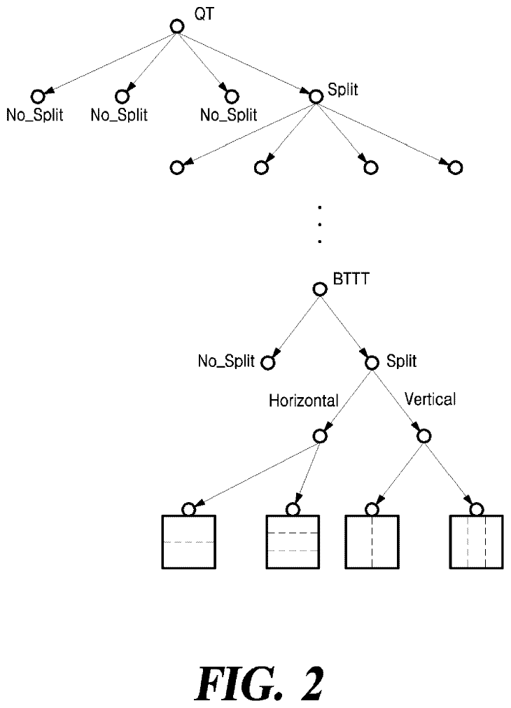

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

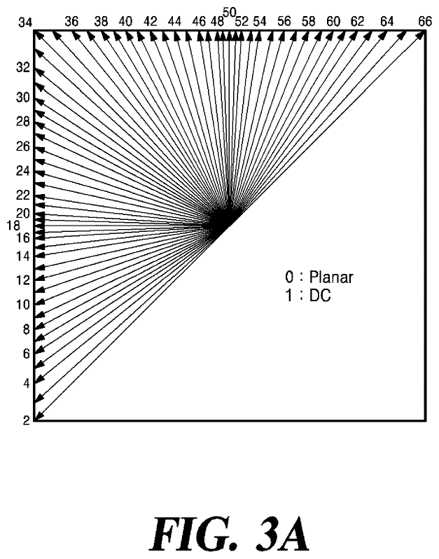

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

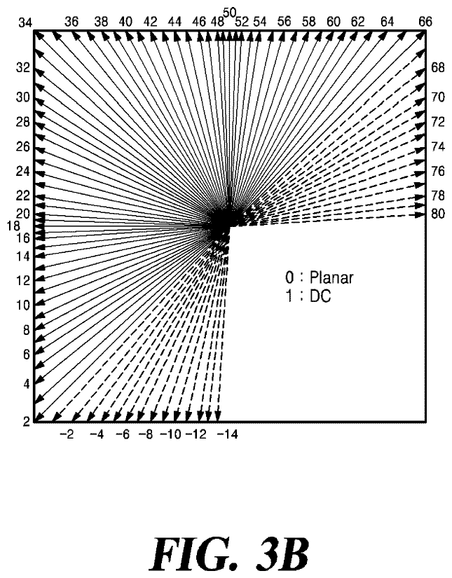

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

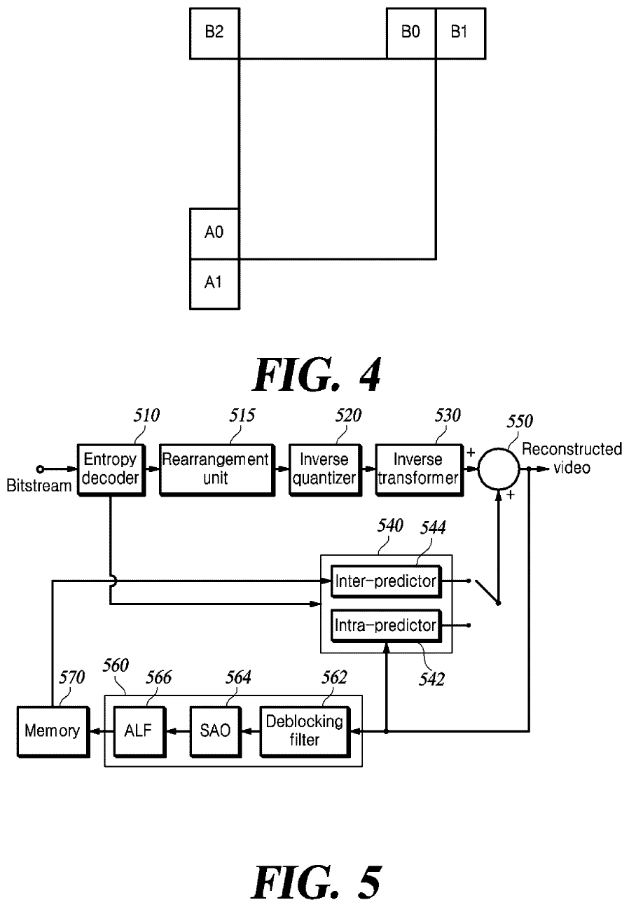

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that intra-predict a current chroma block by using geometric partitioning when predicting a chroma component after predicting and reconstructing a luma component for the current block.

The following embodiments may be performed by the intra predictor 122 in the video encoding device. The following embodiments may also be performed by the intra predictor 542 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Intra Prediction of Chroma Component

Several techniques are introduced to increase coding efficiency by using intra prediction.

In the VVC (Versatile Video Coding) technique, the luma block has intra-prediction modes of 65 subdivided directional modes, i.e., modes 2 to 66 in addition to the non-directional modes, i.e., planar and DC modes, as illustrated in FIG. 3A. The 65 directional modes, planar, and DC modes, are collectively referred to as 67 IPMs.

Depending on the prediction direction utilized by the luma block, the chroma block may also have limited access to intra prediction of these subdivided directional modes. However, the intra prediction of the chroma block may not always utilize the various directional modes available to the luma block except for the horizontal and vertical directions. To be able to use these different directional modes, the prediction mode of the current chroma block needs to be set to DM (direct mode). By setting the prediction mode to DM, the current chroma block may utilize directional modes other than the horizontal and vertical modes of the luma block.

When a chroma block is encoded, the intra-prediction modes that are most frequently used or defaulted to maintain video quality include planar, DC, vertical and horizontal modes, and DM. In DM, the intra-prediction mode of the luma block that spatially corresponds to the current chroma block is used as the intra-prediction mode of the chroma block.

The video encoding device may signal to the video decoding device whether the intra-prediction mode of the chroma block is DM. The video encoding device may communicate the DM to the video decoding device in many ways. For example, the video encoding device may indicate whether the intra-prediction mode of the chroma block is DM by setting intra_chroma_pred_mode, which is information for indicating the intra-prediction mode of the chroma block, to a specific value and transmitting it to the video decoding device.

When the chroma block is encoded in intra-prediction mode, the video encoding device may set the intra-prediction mode IntraPredModeC of the chroma block according to Table 1.

Hereinafter, to distinguish intra_chroma_pred_mode from IntraPredModeC, which are information related to the intra-prediction mode of the chroma block, they are denoted as chroma intra-prediction mode indicator and chroma intra-prediction mode, respectively.

TABLE 1

| | | | lumaIntraPredMode | | | | |
|---|---|---|---|---|---|---|---|
| | | | | | | | X |
| cclm_mode_flag | cclm_mode_idx | intra_chroma_pred_mode | 0 | 50 | 18 | 1 | (0 <= X <= 66) |
| 0 | — | 0 | 66 | 0 | 0 | 0 | 0 |
| 0 | — | 1 | 50 | 66 | 50 | 50 | 50 |
| 0 | — | 2 | 18 | 18 | 66 | 18 | 18 |
| 0 | — | 3 | 1 | 1 | 1 | 66 | 1 |
| 0 | — | 4 | 0 | 50 | 18 | 1 | X |
| 1 | 0 | — | 81 | 81 | 81 | 81 | 81 |
| 1 | 1 | — | 82 | 82 | 82 | 82 | 82 |
| 1 | 2 | — | 83 | 83 | 83 | 83 | 83 |

Here, lumaIntraPredMode is the intra-prediction mode of the luma block corresponding to the current chroma block (hereinafter ‘luma intra-prediction mode’). The lumaIntraPredMode represents one of the prediction modes illustrated in FIG. 3A. For example, in Table 1, lumaIntraPredMode=0 refers to the planar prediction mode and lumaIntraPredMode=1 refers to the DC prediction mode. Cases with lumaIntraPredMode of 18, 50, and 66 indicate directional modes referred to as horizontal, vertical, and VDIA, respectively. On the other hand, cases that intra_chroma_pred_mode=0, 1, 2, and 3 indicate planar, vertical, horizontal, and DC prediction modes, respectively. The case that intra_chroma_pred_mode=4 is DM, where the value of IntraPredModeC, the chroma intra-prediction mode, is set equal to the value of lumaIntraPredMode.

Meanwhile, the process of parsing the intra-prediction mode of the chroma block, performed by the video decoding device, is shown in Table 2.

TABLE 2

```
if( CclmEnabled )
  cclm_mode_flag
if( cclm_mode_flag )
  cclm_mode_idx
else
  intra_chroma_pred_mode
```

The video decoding device parses the cclm_mode_flag, which indicates whether to use cross-component linear model (CCLM) mode. If cclm_mode_flag is 1 to enable CCLM mode, the video decoding device parses cclm_mode_idx which indicates the CCLM mode. Depending on the value of cclm_mode_idx, the CCLM mode may indicate one of the three modes. On the other hand, if cclm_mode_flag is 0, indicating no use of CCLM mode, the video decoding device parses intra_chroma_pred_mode which indicates intra-prediction mode, as described above.

If the CCLM mode is applied for intra prediction of the current chroma block, the video decoding device determines a corresponding region in the luma image corresponding to the current chroma block (hereinafter, the ‘corresponding luma region’). For prediction of the linear model, the left reference pixel and the top reference pixel of the corresponding luma region and the left reference pixel and the top reference pixel of the target chroma block may be utilized. Hereinafter, the left reference pixels and the top reference pixels are commonly referred to as reference pixels, neighboring pixels, or adjacent pixels. Additionally, reference pixels in the chroma channel are referred to as chroma reference pixels, and reference pixels in the luma channel are referred to as luma reference pixels.

In CCLM prediction, a prediction block that is a predictor of the target chroma block is generated by deriving a linear model between the reference pixels in the corresponding luma region and the reference pixels of the chroma block and then applying the linear model to the reconstructed pixels in the corresponding luma region. For example, four pairs of pixels, which are pixels in the peripheral pixel line of the current chroma block and pixels in the corresponding luma region combined, may be used to derive the linear model. In response to the four pairs of pixels, the video decoding device may derive α and β that represent the linear model, as shown in Equation 1.

$$α = \frac{{Y}_{b} - {Y}_{a}}{{X}_{b} - {X}_{a}} , \qquad [ Equation 1 ]$$

$$β = {Y}_{a} - α \cdot {X}_{a}$$

Here, Xₐ and X_{b} each represent the average value of the minimum and second smallest values, and the average value of the maximum and second largest values, of the corresponding luma pixels in the four pairs of pixels. Further, Ya and Yb each represent the average value of the minimum and the second smallest values, and the average value of the maximum and the second largest values, of the chroma pixels in the four pairs of pixels. Then, the video decoding device may use a linear model to generate a predictor pred_{C}(i,j) of the current chroma block from the pixel values rec′_{L}(i,j) of the corresponding luma region, as shown in Equation 2.

pred_{C}(i,j)=α·rec′_{L}(i,j)+β [Equation 2]

As described above, the CCLM mode is divided into three modes, CCLM_LT, CCLM_L, and CCLM_T, depending on the position of the neighboring pixels used in the derivation of the linear model. CCLM_LT mode uses two pixels in each direction from the neighboring pixels adjacent to the left side and top side of the current chroma block. CCLM_L mode uses four pixels from the neighboring pixels adjacent to the left of the current chroma block. Lastly, CCLM_T mode utilizes four pixels from the neighboring pixels adjacent to the top of the current chroma block.

The following embodiments are described about the video decoding device but may be implemented identically or similarly in the video encoding device.

### II. Embodiments According to the Present Disclosure

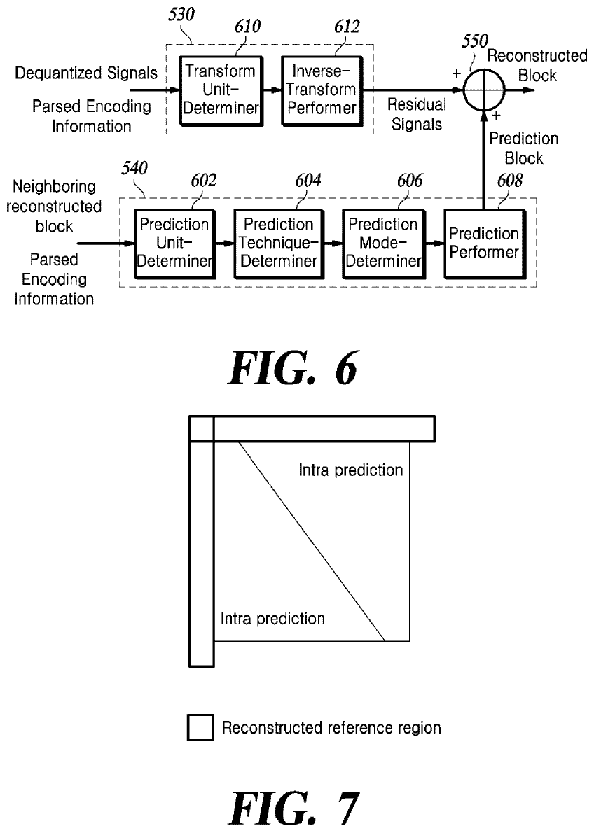

FIG. 6 is a block diagram detailing a portion of a video decoding device, according to at least one embodiment of the present disclosure.

The video decoding device according to some embodiments can determine prediction unit and transform unit, and with respect to a current block corresponding to the determined unit, perform a prediction and an inverse transform by using a determined prediction technique and prediction mode, to finally generate a reconstructed block of the current block. The operations illustrated in FIG. 6 may be performed by an inverse transformer 530, a predictor 540, and an adder 550 of the video decoding device. On the other hand, the same operations as illustrated in FIG. 6 may be performed by the inverse transformer 165, the picture splitter 110, the predictor 120, and the adder 170 of the video encoding device. In this case, the video decoding device uses encoding information parsed from the bitstream, but the video encoding device may use encoding information set from a higher level in terms of minimizing rate distortion. Hereinafter, for convenience of description, the embodiments are described centering on the video decoding device.

As illustrated in FIG. 5, the predictor 540 includes the intra predictor 542 and the inter predictor 544, depending on the prediction technique, but as illustrated in FIG. 6, the predictor 540 may include all or part of a prediction unit-determiner 602, a prediction technique-determiner 604, a prediction mode-determiner 606, and a prediction performer 608.

When the color format of the input video is a YUV format (YUV420, YUV411, YUV422, YUV444, and the like), the video decoding device may perform prediction and reconstruction of the luma component and then may perform prediction and reconstruction of the chroma component. In other words, the luma component and the chroma component may be sequentially reconstructed by the components illustrated in FIG. 6. On the other hand, when the color format of the input video is RGB, the video encoding device may perform a color format transform from RGB to YUV, and then may encode the transformed video. Here, in the case of the YUV format, the color format represents a corresponding relation between pixels in the luma component and pixels in the chroma component.

The prediction unit-determiner 602 determines a prediction unit (PU). The prediction technique-determiner 604, with respect to the prediction unit, determines a prediction technique, e.g., intra prediction, inter prediction, or intra block copy (IBC) mode, palette mode, and the like. The prediction mode-determiner 606 determines a detailed prediction mode for the prediction technique. The prediction performer 608 generates a prediction block of the current block according to the determined prediction mode.

The inverse transformer 530 includes a transform unit-determiner 610 and an inverse transform-performer 612. The transform unit-determiner 610 determines a transform unit (TU) with respect to the inverse quantization signals of the current block, and the inverse transform-performer 612 inversely transforms the transform unit represented by the inverse quantization signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 602 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed for the prediction unit of the chroma component.

The prediction technique-determiner 604 determines a prediction technique for the prediction units. As described above, the prediction technique may be one of inter prediction, intra prediction, IBC mode, and palette mode. In this case, the prediction technique of the chroma component may be determined to be the same as the prediction technique of the corresponding luma component without signaling and parsing separate information.

The following describes a case where the prediction technique of the current chroma block is intra prediction, when the prediction mode-determiner 606 determines the prediction mode of the current chroma block, and the prediction performer 608 predicts the current chroma block.

In one example, the prediction mode-determiner 606 may decode an intra-prediction mode utilizing the neighboring reconstructed chroma samples of the current chroma block, and then may determine the decoded prediction mode to be the prediction mode of the current chroma block. At this time, the prediction performer 608 may generate a prediction block of the current chroma block by using the neighboring reconstructed chroma samples according to the determined intra-prediction mode.

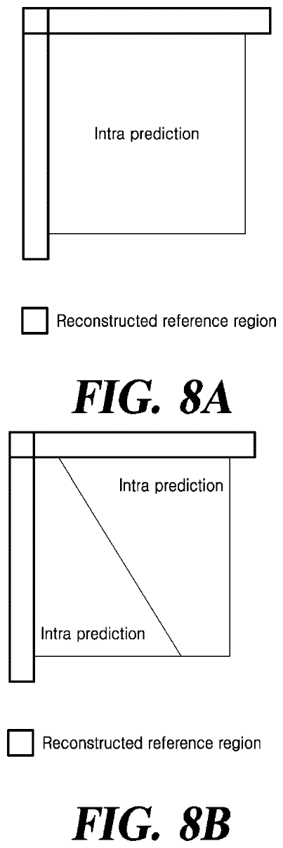

As an example, the following describes a case where the luma component and the chroma component have an identical block partition structure, and the corresponding luma block is predicted according to the spatial geometric partitioning mode (SGPM) when it is predicted according to the intra prediction mode, as illustrated in FIG. 7. Here, corresponding luma block denotes the luma block co-located with the current chroma block. The SGPM applies the geometric partitioning mode to intra-predicted luma blocks. At this time, the partitioned luma subregions may be predicted according to different intra-prediction modes. The video encoding device may signal a flag to the video decoding device, indicating whether SGPM is to be applied to the luma block.

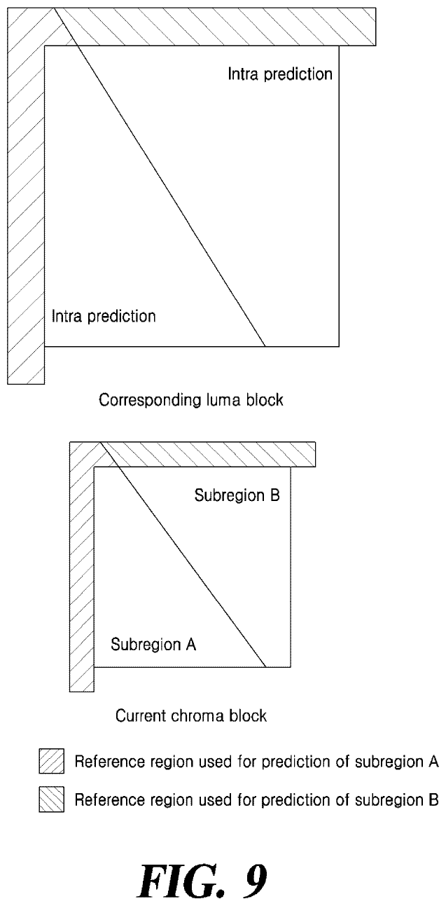

The prediction mode-determiner 606 may determine the prediction mode of the current chroma block as follows, by referring to the examples of FIGS. 8A and 8B.

The prediction mode-determiner 606 decodes a flag indicating whether SGPM is applied to the current chroma block (hereinafter, ‘SGPM flag’). Based on the SGPM flag, the prediction mode-determiner 606 may determine a prediction mode for the current chroma block.

If the SGPM flag is false, the prediction mode-determiner 606 may decode the prediction mode of the current chroma block without partitioning into subregions, as illustrated in FIG. 8A. In this case, the prediction mode of the decoded current chroma block may be one of the prediction modes such as vertical, horizontal, DC, and planar modes, DM (direct mode), a cross-component-based prediction (CC-based prediction), and the like. When the decoded prediction mode is DM, used as the prediction mode of the current chroma block may be the prediction mode of the subregion containing the center position or the top-left position of the luma block, or the prediction mode of the subregion containing the most luma samples among the subregions. As an example CC-based prediction for the current chroma block, the CCLM (cross-component linear model) as described above may be utilized.

If the SGPM flag is true, the prediction mode-determiner 606 may determine that the prediction mode of the current chroma block is SGPM, as illustrated in FIG. 8B. The prediction mode-determiner 606 may partition the current chroma block into subregions by using the sampling of the color format of the current picture and the geometric partitioning mode of the corresponding luma block, and then may determine the prediction mode of each subregion according to the following embodiments.

In one example, the prediction mode-determiner 606 may decode the prediction mode of the subregion. In this case, the prediction mode of the subregion may be one of vertical, horizontal, DC, and planar modes, or DM. When DM is determined, used as the prediction mode of the subregion may be the prediction mode of the luma subregion corresponding (hereinafter called ‘corresponding luma subregion’) to the chroma subregion. The corresponding luma subregion exists within the corresponding luma block.

Alternatively, the prediction mode of the subregion may be a prediction mode derived by using neighboring reconstructed samples of the current chroma block. In this case, the directionality information of the neighboring reconstructed samples may be used to derive the prediction mode.

Yet alternatively, the prediction mode of the subregion may be determined as a CC-based prediction. In CC-based prediction, the current subregion is predicted from the corresponding luma subregion based on the relationship between the neighboring reconstructed samples of the current subregion and the neighboring reconstructed samples of the corresponding luma subregion.

At this time, the CC-based prediction may be performed for each subregion by signaling/parsing a separate cross-component prediction flag for each subregion. Here, the cross-component prediction flag may indicate whether CC-based prediction is performed for the subregion. For example, if the cross-component prediction flag is true, the prediction mode of the relevant subregion may be determined to be CC-based prediction. On the other hand, if the cross-component prediction flag is false, the prediction mode of the relevant subregion may be one of the vertical, horizontal, DC, and planar modes, or DM, or a prediction mode derived by using neighboring reconstructed samples.

As another example, by signaling/parsing the cross-component prediction flag for the current chroma block, the CC-based prediction may be performed on subblocks within the current chroma block. Here, the cross-component prediction flag may indicate whether CC-based prediction is to be performed on the subregions. For example, if the cross-component prediction flag is true, the prediction mode of the subregions may be determined to be CC-based prediction. On the other hand, if the cross-component prediction flag is false, the prediction mode of the subregions may be one of the vertical, horizontal, DC, and planar modes, or DM, or a prediction mode derived by using neighboring reconstructed samples.

Alternatively, whether the CC-based prediction is to be applied may be determined without signaling/parsing separate information for each subregion. If the subregion is a region having no restriction of CC-based prediction, the prediction mode of the subregion is determined to be CC-based prediction. On the other hand, if the subregion is a region where CC-based prediction is restricted, the prediction mode of the subregion may be one of the vertical, horizontal, DC, and planar modes, or DM, or a prediction mode derived by using neighboring reconstructed samples.

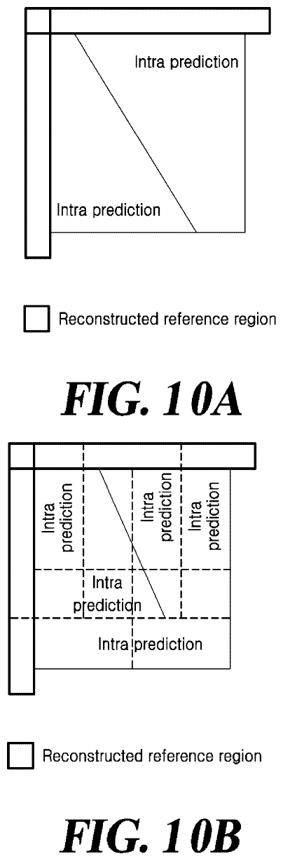

To derive the equations used for CC-based prediction, the positions of the samples of the luma component and the chroma component may be determined according to the geometric partitioning mode of the current chroma block, as illustrated in FIG. 9.

In one example, if the number of chroma reference samples used for prediction in each subregion is less than a threshold (tr), CC-based prediction may be limited in that subregion. In this case, the threshold (tr) may be predetermined by an agreement between the video encoding device and the video decoding device. Alternatively, the threshold may be implicitly determined based on the size of the current chroma block and the size of the subregion.

Furthermore, if the CC-based prediction is limited based on the number of reference samples as described above, the prediction mode of the relevant subregion may be determined according to the DM without additional signaling/parsing of separate information.

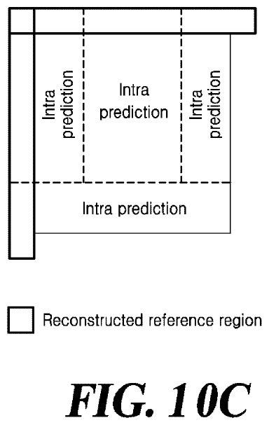

As another example, the following describes a case where the luma component and the chroma component have different block partition structures, and the corresponding luma region is predicted according to the intra-prediction mode. Here, the corresponding luma region indicates a luma region co-located with the current chroma block. The prediction mode-determiner 606 may determine the prediction mode of the current chroma block based on the prediction mode of the luma block in the corresponding luma region, as illustrated in FIGS. 10A to 10C, as follows. Here, the corresponding luma region indicates a luma region at a corresponding position of the current chroma block.

As an example, if the corresponding luma region is intra-predicted and predicted according to SGPM, as illustrated in FIG. 10A, the prediction mode of the current chroma block may be determined as shown in the examples of FIGS. 8A and 8B.

As another example, the following describes a case where a corresponding luma region includes luma blocks predicted according to SGPM, as illustrated in FIG. 10B. In this case, if a single luma block is predicted according to the SGPM, the geometric partitioning mode of that block may be utilized. If multiple luma blocks are predicted according to SGPM, the geometric partitioning mode of the block with the largest size may be utilized. Alternatively, if predicted by SGPM is a block containing samples at the center of the corresponding luma region or samples adjacent to the top-left boundary, the geometric partitioning mode of that block may be used. The following embodiments may be applied when the SGPM flag is true.

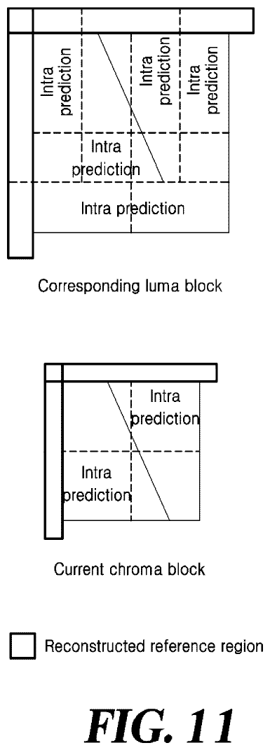

The prediction mode-determiner 606 may apply block partitioning information to the current chroma block according to the sampling of the color format, based on the geometric partitioning mode of the block. The prediction mode of the current chroma block may be determined to be the SGPM performing a prediction of each subregion, as illustrated in FIG. 11.

In one example, the prediction mode-determiner 606 may decode the prediction mode of the subregion. In this case, the prediction mode of the subregion may be one of vertical, horizontal, DC, and planar modes, or DM. If the subregion's prediction mode is determined to be DM, the prediction mode of the corresponding luma subregion may be used as the subregion's prediction mode. The corresponding luma subregion exists within the corresponding luma block.

Alternatively, the prediction mode of the subregion may be derived by using neighboring reconstructed samples of the current chroma block. In this case, the directionality information of the neighboring reconstructed samples may be used to derive the prediction mode.

Alternatively, the prediction mode of the subregion may be determined to be a CC-based prediction. In the CC-based prediction, the current subregion is predicted from the corresponding luma subregion based on the relationship between the current subregion's neighboring reconstructed samples and the corresponding luma subregion's neighboring reconstructed samples.

In this case, the CC-based prediction may be performed for each subregion by signaling/parsing a separate cross-component prediction flag for each subregion. Here, the cross-component prediction flag may indicate whether a CC-based prediction is to be performed for a given subregion. For example, if the cross-component prediction flag is true, the prediction mode of the relevant subregion may be determined to be CC-based prediction. On the other hand, if the cross-component prediction flag is false, the prediction mode of the relevant subregion may be one of the vertical, horizontal, DC, and planar modes, or DM, or a prediction mode derived by using neighboring reconstructed samples.

As another example, by signaling/parsing a cross-component prediction flag for the current chroma block, a CC-based prediction may be performed on subblocks within the current chroma block. Here, the cross-component prediction flag may indicate whether CC-based prediction is to be performed on subregions. For example, if the cross-component prediction flag is true, the prediction mode of the subregions may be determined to be CC-based prediction. On the other hand, if the cross-component prediction flag is false, the prediction mode of the subregions may be one of the vertical, horizontal, DC, and planar modes, or DM, or a prediction mode derived by using neighboring reconstructed samples.

Alternatively, whether CC-based prediction is to be applied may be determined without signaling/parsing separate information for each subregion. If the subregion is a region with no restriction of the CC-based prediction, the prediction mode of the subregion is determined to be the CC-based prediction. On the other hand, if the subregion is a region where the CC-based prediction is restricted, the prediction mode of the subregion may be vertical, horizontal, DC, and planar modes, and DM, or a prediction mode derived by using neighboring reconstructed samples.

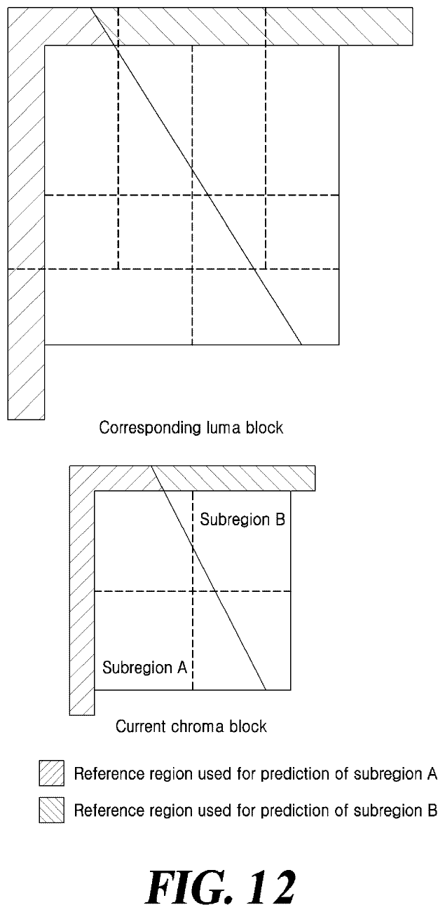

To derive the equations used for CC-based prediction, the positions of the samples of the luma component and the chroma component may be determined according to the geometric partitioning mode of the current chroma block, as illustrated in FIG. 12.

In one example, if the number of chroma reference samples used for prediction in each subregion is less than a threshold (tr), CC-based prediction may be limited in that subregion. In this case, the threshold (tr) may be predetermined by an agreement between the video encoding device and the video decoding device. Alternatively, the threshold may be implicitly determined based on the size of the current chroma block and the size of the subregion.

Furthermore, if the CC-based prediction is limited based on the number of reference samples as described above, the prediction mode of the relevant subregion may be determined to be the prediction mode according to the DM without additional signaling/parsing of additional information.

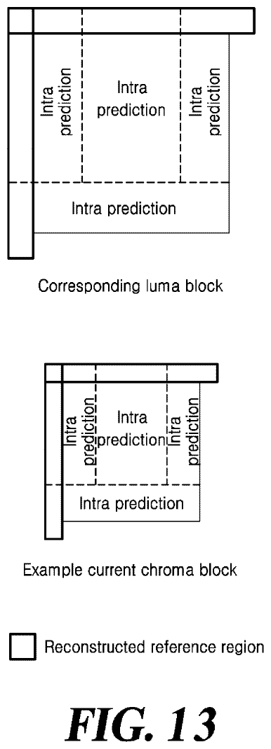

As yet another example, the following describes a case where a corresponding luma region is predicted and reconstructed while partitioned into multiple blocks, as illustrated in FIG. 10C. The following embodiments may be applied when the SGPM flag is true. The prediction mode-determiner 606 may apply the partitioning information of the corresponding luma region to the current chroma block according to the sampling of the color format, as illustrated in FIG. 13. The prediction mode of the current chroma block may be determined to be the SGPM performing the prediction of each subregion. In other words, the current chroma block may be partitioned into subregions according to the partitioning information of the corresponding luma region.

In one example, the prediction mode-determiner 606 may decode a prediction mode of the subregion. The prediction mode of the subregion may be one of vertical, horizontal, DC, and planar modes, or DM. If the subregion's prediction mode is determined to be DM, the prediction mode of the corresponding luma subregion may be used as the subregion's prediction mode. The corresponding luma subregion exists within the corresponding luma block.

Alternatively, the prediction mode of the subregion may be derived by using neighboring reconstructed samples of the current chroma block. In this case, to derive the prediction mode, the directionality information of the neighboring reconstructed samples may be used.

Alternatively, the prediction mode of the subregion may be determined to be a CC-based prediction. In CC-based prediction, the current subregion is predicted from the corresponding luma subregion based on a relationship between the current subregion's neighboring reconstructed samples and the corresponding luma subregion's neighboring reconstructed samples.

At this time, a CC-based prediction may be performed for each subregion by signaling/parsing a separate cross-component prediction flag for each subregion. Here, the cross-component prediction flag may indicate whether a CC-based prediction is to be performed on a given subregion. For example, if the cross-component prediction flag is true, the prediction mode of the relevant subregion may be determined to be CC-based prediction. On the other hand, if the cross-component prediction flag is false, the prediction mode of the relevant subregion may be vertical, horizontal, DC, and planar modes, and DM, or a prediction mode derived by using neighboring reconstructed samples.

As another example, by signaling/parsing a cross-component prediction flag for the current chroma block, a CC-based prediction may be performed on subblocks within the current chroma block. Here, the cross-component prediction flag may indicate whether CC-based prediction is to be performed on the subregions. For example, if the cross-component prediction flag is true, the prediction mode of the subregions may be determined to be CC-based prediction. On the other hand, if the cross-component prediction flag is false, the prediction mode of the subregions may be one of the vertical, horizontal, DC, and planar modes, or DM, or a prediction mode derived by using neighboring reconstructed samples.

Alternatively, whether CC-based prediction is to be applied may be determined without signaling/parsing separate information for each subregion. If the subregion is a region with no restriction of CC-based prediction, the prediction mode of the subregion is determined to be CC-based prediction. On the other hand, if the subregion is a region where CC-based prediction is restricted, the prediction mode of the subregion may be one of the vertical, horizontal, DC, and planar modes, or DM, or a prediction mode derived by using neighboring reconstructed samples.

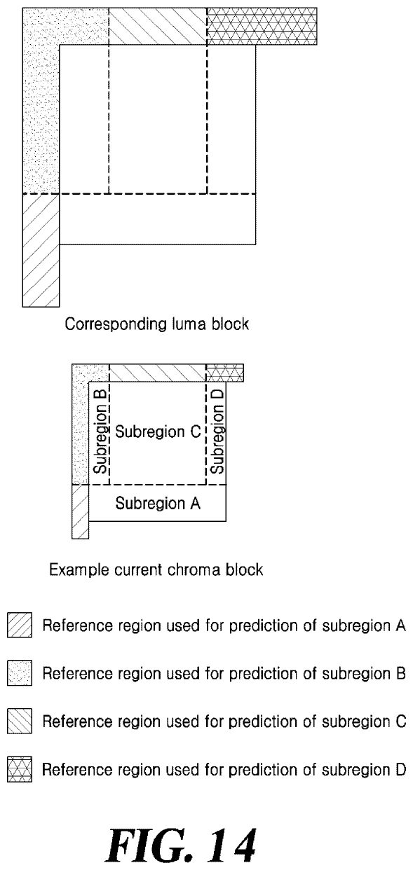

To derive the equations used for CC-based prediction, the positions of the samples of the luma component and the chroma component may be determined according to the geometric partitioning mode of the current chroma block, as illustrated in FIG. 14.

In one example, if the number of chroma reference samples used for prediction in each subregion is less than a threshold (tr), CC-based prediction may be limited in that subregion. In this case, the threshold (tr) may be predetermined by an agreement between the video encoding device and the video decoding device. Alternatively, the threshold may be implicitly determined based on the size of the current chroma block and the size of the subregion.

Furthermore, if the CC-based prediction is limited based on the number of reference samples as described above, the prediction mode of the relevant subregion may be determined according to the DM without additional signaling/parsing of separate information.

On the other hand, if the current chroma block is partitioned into multiple subregions, the prediction performer 608 predicts the subregions in order by using the prediction mode determined for each subregion. After predicting the last subregion, the prediction performer 608 determines a blending area. The prediction performer 608 may generate a final chroma prediction block of the current chroma block by weight summing the subregions by using weights according to the blending area.

The following describes a linear prediction relationship established for a subregion provided the prediction mode of the current chroma block is determined as in the example of FIG. 8B or FIG. 11, and one or more subregions are CC-based predicted based on the geometric partitioning mode as in the example of FIGS. 9 and 12; or, provided the prediction mode of the current chroma block is determined as in the example of FIG. 13, and one or more subregions are CC-based predicted based on the geometric partitioning mode as in the example of FIG. 14. The video decoding device may use samples in the determined reconstructed region of each component of that subregion to derive parameters α and β representing the linear relationship between components.

On the other hand, if the luma component and the chroma component have different resolutions, depending on the color format of the input video, the video decoding device may downsample a region of the reconstructed luma component, and use the luma samples in the downsampled region and the samples in the reconstructed region around the current chroma block to model the linear relationship. The downsampling filter may be fixed, or the video encoding device may signal the coefficients of the downsampling filter to the video decoding device.

In one example, the video decoding device may derive the parameters by utilizing all of the samples in the determined reconstructed region of each component. For example, after ordering the samples in the reconstructed region of the luma component in descending order, and ordering the samples in the reconstructed region of the chroma component in descending order, the video decoding device may calculate Lₘ₋ₘₐₓ, Lₘ₋ₘᵢₙ, Cₘ₋ₘₐₓ, and Cₘ₋ₘᵢₙ for the respective components, corresponding to the average value of the maximum and the second largest value, and the average value of the minimum and the second smallest value. Then, the video decoding device may derive α and β as shown in Equation 3.

$$α = \frac{{L}_{m - max} - {L}_{m - min}}{{C}_{m - max} - {C}_{m - min}} , \qquad [ Equation 3 ]$$

$$β = {L}_{m - min} - α \cdot {C}_{m - min}$$

As another example, the video decoding device may derive the parameters by using only such samples in the reconstructed region of each component that correspond to predefined positions based on the block size. For example, after ordering the samples at the predefined positions in the reconstructed region of the luma component in descending order, and ordering the samples at the predefined positions in the reconstructed region of the chroma component in descending order, the video decoding device calculates Lₘ₋ₘₐₓ, Lₘ₋ₘᵢₙ, Cₘ₋ₘₐₓ, and Cₘ₋ₘᵢₙ for the respective components, corresponding to the average value of the maximum value and the second largest value, and the average value of the minimum value and the second smallest value. Then, the video decoding device may derive α and β as shown in Equation 3.

As another example, the video decoding device may adaptively use the downsampling filter according to the prediction mode of the subregion within the corresponding luma block.

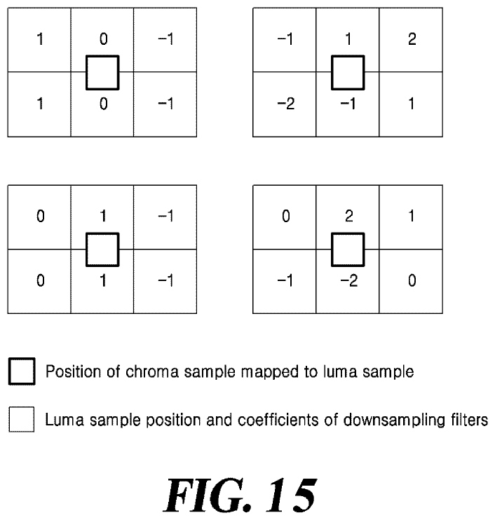

For example, as illustrated in FIG. 15, a plurality of downsampling filters may be predefined by an agreement between the video encoding device and the video decoding device. The video decoding device may adaptively determine the downsampling filter based on a prediction mode of a subregion within a corresponding luma block of the chroma subregion.

As another example, the downsampling filters corresponding to the intra-prediction mode may be predefined by an agreement between the video encoding device and the video decoding device. The video decoding device may derive parameters for CC-based prediction by using the downsampling filter corresponding to the prediction mode of the subregion within the corresponding luma block of the chroma subregion.

Then, the video decoding device may calculate the predicted sample Pred_{Chroma} of the chroma component by using the calculated parameters as shown in Equation 4.

Pred_{Chroma}=α·Rec′_{L}+β [Equation 4]

In the prediction process, such as in Equation 4, Rec′_{L} may be a sample value in the corresponding luma block or a sample value in the downsampled corresponding luma block, and Pred_{Chroma} may be a sample value in the current chroma block. In the parameter-deriving process described above, Rec′_{L} may be a neighboring reconstructed sample value of the corresponding luma block or a neighboring reconstructed sample value of the downsampled corresponding luma block, and Pred_{Chroma} may be a neighboring reconstructed sample value of the chroma component.

The following describes another linear prediction relationship established for a subregion provided the prediction mode of the current chroma block is determined as in the example of FIG. 8B or FIG. 11, and one or more subregions are CC-based predicted based on the geometric partitioning mode as in the example of FIGS. 9 and 12; or, provided the prediction mode of the current chroma block is determined as in the example of FIG. 13, and one or more subregions are CC-based predicted based on the geometric partitioning mode as in the example of FIG. 14. The video decoding device may use the samples in the determined reconstructed region of each component of the relevant subregion to derive the parameters α_{T} (T=0, 1, 2) and β representing the relationship between the components. The video decoding device may then calculate the predicted sample Pred_{Chroma} of the chroma component as shown in Equation 5 or Equation 6.

$${Pred}_{Chroma} = {α}_{0} \cdot {Rec}_{L}^{′} + {α}_{1} \cdot {Rec}_{L}^{″} + β \qquad [ Equation 5 ]$$

$${Pred}_{Chroma} = {α}_{0} \cdot {Rec}_{L}^{′} + {α}_{1} \cdot {Rec}_{L}^{″} + {α}_{2} \cdot ( ( {Rec}_{L}^{′′′} + midVal ) ≫ bitDepth ) + β \qquad [ Equation 6 ]$$

In a prediction process such as Equation 5 or Equation 6, Rec_{L}′, Rec_{L} “, and Rec_{L}” may be sample values in the corresponding luma block or sample values in the downsampled corresponding luma block, and Pred_{Chroma} may be sample values in the current chroma block. In the parameter deriving process, Rec_{L}′, Rec_{L} “, and Rec_{L}” may be neighboring reconstructed sample values of the corresponding luma block or neighboring reconstructed sample values of the downsampled corresponding luma block, and Pred_{Chroma} may be neighboring reconstructed sample values of the chroma component. Further, midVal may be 1>>bitDepth, where bitDepth indicates the bit depth of the inputted video.

On the other hand, depending on the color format of the input video, if the luma component and the chroma component have different resolutions, the video decoding device may downsample a region of the reconstructed luma component and model a linear relationship by using the luma samples in the downsampled region and the samples in the neighboring reconstructed region of the current chroma block. The downsampling filter may be fixed, or the video encoding device may signal the coefficients of the downsampling filter to the video decoding device.

In one example, when modeling is performed by using Equation 5, Rec_{L}′ and Rec_{L}″ may be luma sample values reconstructed by different downsampling filters.

For example, Rec_{L}′ may be obtained by the same downsampling filter on a coding tree unit (CTU), slice, picture, or sequence basis. The downsampling filter that generates Rec_{L}″ may be derived according to the prediction mode of the subregion of the corresponding luma block. The downsampling filter that generates Rec_{L}″ may be derived by using a loss function, as described in a later embodiment. Alternatively, the downsampling filter generating Rec_{L}″ may be determined according to signaling/parsing between the video encoding device and the video decoding device.

Further, when modeling using Equation 6, Rec_{L}′, Rec_{L}″, and Rec_{L}″ may be luma sample values reconstructed by different downsampling filters.

For example, Rec_{L}″ may be obtained by the same downsampling filter on a coding tree unit (CTU), slice, picture, or sequence basis. The downsampling filter that generates Rec_{L}″ may be derived according to the prediction mode of the subregion of the corresponding luma block. The downsampling filter that generates Rec_{L}″ may be derived by using a loss function, as described in a later embodiment. Alternatively, the downsampling filter generating Rec_{L}″ may be determined according to signaling/parsing between the video encoding device and the video decoding device. Rec_{L}″ may be calculated by the same downsampling filter as the downsampling filter used to calculate Rec_{L}′ or Rec_{L}″.

The following describes embodiments related to determining a blending area.

The video decoding device may, after generating the prediction signals of each subregion to generate a final prediction block of the current chroma block, explicitly or implicitly determine a final blending area where blending is to be performed during the weighted summation process. Then, the video decoding device may calculate a blending matrix to be used in the weighted summation process, based on the determined final blending area.

In one example, the blending area may be determined to be a fixed area based on the size of the current chroma block and the derived geometric partitioning mode.

Alternatively, the blending area may be explicitly determined between the video encoding device and the video decoding device by signaling/parsing a BlendingArea_idx indicative of the blending area.

Alternatively, the blending area may be implicitly determined based on the process of determining the blending area. For example, after calculating the initial prediction signals of each subregion, the video decoding device may implicitly determine the blending area by using the neighboring initial predicted values of the geometrical partitioning boundary.

Meanwhile, the video decoding device may calculate a blending matrix W_{B} based on the implicitly or explicitly determined final blending area. The value of each coefficient (W_{B}(i,j)) in the blending matrix may be an integer value between 0 and 2ⁿ (where n is an integer greater than or equal to 0). In this case, n may be determined based on the size of the current block and/or the geometric partitioning mode.

Embodiments related to weighted summing are described below.

For example, if the current chroma block includes two subregions, the video decoding device may weight sum the initial prediction signals P₀ and P₁ by using the blending matrix W_{B} to generate a final prediction block P_{G} as shown in Equation 7.

P_{G}(i,j)=(W_{B}(i,j)×P₀+(2ⁿ−W_{B}(i,j)×P₁+(2ⁿ−1)>>n [Equation 7]

In Equation 7, each of the initial prediction signals P₀ and P₁ of the two subregions may be generated in a region of the current chroma block by using, for example, a prediction mode of each subregion.

Further, if the current chroma block includes two or more subregions, the video decoding device may generate the prediction blocks (P_{G}^{k}, k=0, 1, . . . , T−1) by weight summing the initial prediction signals P₀ and P₁ on both sides by using the blending matrix W_{B} calculated in the process of determining the blending area based on each geometrical partitioning boundary, as shown in Equation 7. Here, T (a natural number) represents the number of geometric partitioning boundaries existing between the two subregions, i.e., the number of blending matrices W_{B} according to the geometric partitioning boundaries. Used as an order for generating the P_{G}^{k} may be a z-scan order using the top-left corner of the current chroma block as a reference. The video decoding device may generate all the prediction blocks P_{G}^{k} of the two neighboring subregions for each geometrical partitioning boundary, and then may sum the generated prediction blocks to generate the final prediction block as shown in Equation 8.

$${P}_{G} ( i , j ) = {\sum }_{k = 0}^{T - 1} {P}_{G}^{k} ( i , j ) \qquad [ Equation 8 ]$$

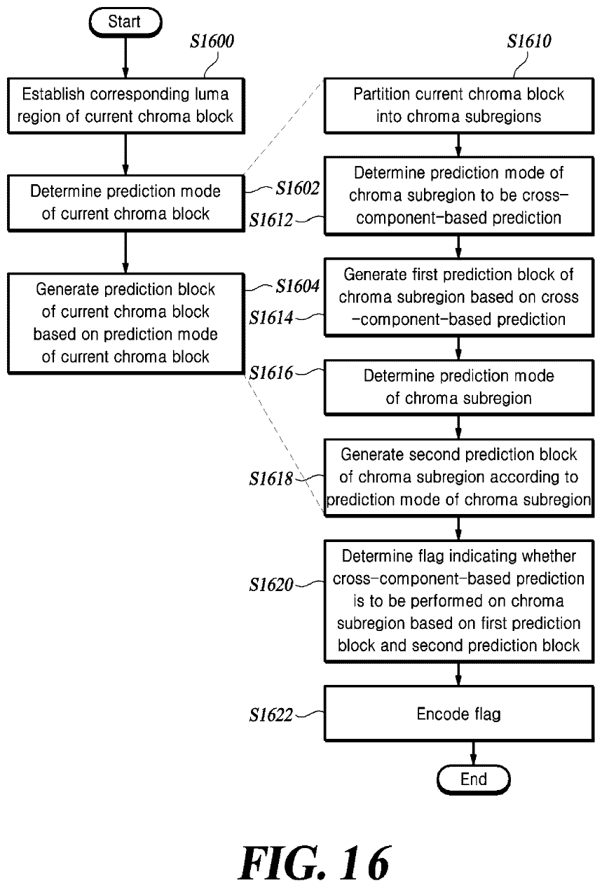

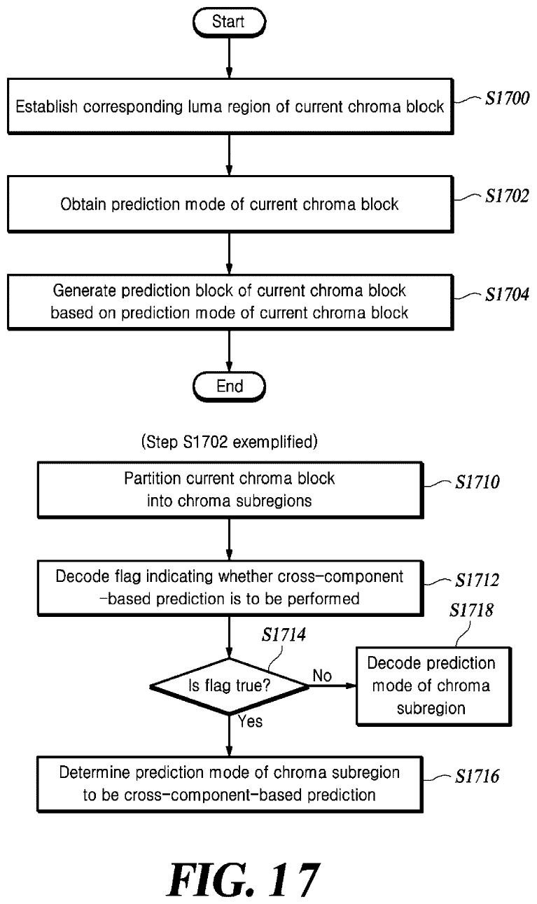

Hereinafter, a method is described for predicting a current chroma block by using the illustrations of FIGS. 16 and 17. In this case, the illustrations of FIGS. 16 and 17 assume that the SGPM flag is true.

FIG. 16 is a flowchart of a method of predicting a current chroma block by the video encoding device, according to at least one embodiment of the present disclosure.

The video encoding device establishes a corresponding luma region of the current chroma block from the reconstructed region of the luma component (S1600). Here, the corresponding luma region represents a luma block or luma region co-located with the current chroma block and is an intra-predicted region.

The video encoding device determines the prediction mode of the current chroma block based on whether the SGPM is to be applied to the corresponding luma region, the intra-prediction mode of the corresponding luma region, and the block partition structures of the luma component and the chroma component (S1602).

The video encoding device generates a prediction block of the current chroma block based on the prediction mode of the current chroma block (S1602).

Meanwhile, when the luma component and the chroma component have the same block partition structure, and when the corresponding luma regions are predicted according to the spatial geometric partitioning mode, Steps S1602 and S1604 may include the following steps of S1610 to S1618, and the video encoding device may further perform steps after S1620.

The video encoding device partitions the current chroma block into chroma subregions by using the color format of the current picture and the geometric partitioning mode of the corresponding luma region (S1610).

The video encoding device determines the prediction mode of the chroma subregion to be cross-component-based prediction (S1612).

The video encoding device generates the first prediction block of the chroma subregion based on the cross-component-based prediction (S1614).

The video encoding device determines a prediction mode of the chroma subregion (S1616). For example, the video encoding device may determine the prediction mode of the chroma subregion to be one of the vertical, horizontal, DC, and planar modes, or DM, or a prediction mode derived by using neighboring reconstructed samples of the current chroma block. In this case, the video encoding device may determine the prediction mode of the chroma subregion in terms of optimizing bit rate distortion.

The video encoding device generates a second prediction block of the chroma subregion according to the prediction mode of the chroma subregion (S1618).

The video encoding device determines a flag indicating whether a cross-component-based prediction is to be performed on the chroma subregion based on the first prediction block and the second prediction block (S1620). In terms of optimizing rate distortion, the video encoding device may determine the value of the flag based on the first prediction block and the second prediction block. For example, if the first prediction block is optimal, the video encoding device may set the flag to true. On the other hand, if the second prediction block is optimal, the video encoding device may set the flag to false.

The video encoding device encodes the determined flag (S1622).

Additionally, if the flag is false, the video encoding device may encode a prediction mode of the chroma subregion determined in Step S1616.

As another example, when the luma component and the chroma component have different block partition structures, and when the corresponding luma region includes blocks predicted according to the SGPM, Step S1610 may be replaced as follows.

The video encoding device may partition the current chroma block into chroma subregions by using the color format of the current picture and the geometric partitioning mode of the prediction block according to the SGPM. The video encoding device may then perform Steps S1612 through S1622.

As another example, when the luma component and the chroma component have different block partition structures, and when the corresponding luma region is partitioned into multiple blocks, Step S1610 may be replaced as follows.

The video encoding device partitions the current chroma block into chroma subregions by using the color format of the current picture and the partitioning information of the corresponding luma region. The video encoding device may then perform Steps S1612 through S1622.

FIG. 17 is a flowchart of a method of predicting a current chroma block by the video decoding device, according to at least one embodiment of the present disclosure.

The video decoding device establishes a corresponding luma region of the current chroma block from the reconstructed region of the luma component (S1700). Here, the corresponding luma region represents a luma block or luma region co-located with the current chroma block and is an intra-predicted region.

The video decoding device obtains the prediction mode of the current chroma block based on whether the SGPM is to be applied to the corresponding luma region, the intra-prediction mode of the corresponding luma region, and the block partition structures of the luma component and the chroma component (S1702).

The video decoding device generates a prediction block of the current chroma block based on the prediction mode of the current chroma block (S1704).

In one example, when the luma component and the chroma component have an identical block partition structure, and when the corresponding luma regions are predicted according to the SGPM, Step S1702 may include the following steps.

The video decoding device partitions the current chroma block into chroma subregions by using the color format of the current picture and the geometric partitioning mode of the corresponding luma region (S1710).

The video decoding device decodes, from a bitstream, a flag indicating whether a cross-component-based prediction is to be performed (S1712).

The video decoding device checks the flag (S1714).

If the flag is true (Yes in S1714), the video decoding device determines the prediction mode of the chroma subregion to be cross-component-based prediction (S1716).

On the other hand, if the flag is false (No in S1714), the video decoding device decodes the prediction mode of the chroma subregion (S1718). Here, the prediction mode of the chroma subregion may be one of the vertical, horizontal, DC, and planar modes, or DM (Direct mode), or a prediction mode derived by using neighboring reconstructed samples of the current chroma block.

As another example, when the luma component and the chroma component have different block partition structures, and when the corresponding luma region includes blocks predicted according to the SGPM, Step S1710 may be replaced as follows.

The video decoding device partitions the current chroma block into chroma subregions by using the color format of the current picture and the geometric partitioning mode of the prediction block according to the SGPM. Then, the video decoding device may obtain the prediction mode of each chroma subregion according to Steps S1712 to S1718.

As another example, when the luma component and the chroma component have different block partition structures, and when the corresponding luma region is partitioned into multiple blocks, Step S1710 may be replaced as follows.

The video decoding device partitions the current chroma block into chroma subregions by using the color format of the current picture and the partitioning information of the corresponding luma region. Then, the video decoding device may obtain a prediction mode of each chroma subregion according to Steps S1712 to S1718.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
542: intra predictor
602: prediction unit-determiner
604: prediction technique-determiner
606: prediction mode-determiner
608: prediction performer

1. A method of reconstructing a current chroma block by a video decoding device, the method comprising:
establishing a corresponding luma region of the current chroma block from a reconstructed region of a luma component, the corresponding luma region being an intra-predicted region and representing a luma block or a luma region co-located with the current chroma block;
obtaining a prediction mode of the current chroma block based on whether a spatial geometric partitioning mode is applied to the corresponding luma region, an intra-prediction mode of the corresponding luma region, and block partition structures of the luma component and a chroma component; and
generating a prediction block of the current chroma block based on the prediction mode of the current chroma block.

2. The method of claim 1, wherein obtaining the prediction mode of the current chroma block comprises, when the block partition structures of the luma component and the chroma component are equal, and when the corresponding luma region is predicted according to the spatial geometric partitioning mode:
partitioning the current chroma block into chroma subregions by using a color format of a current picture and a geometric partitioning mode of the corresponding luma region; and
obtaining a prediction mode of each of the chroma subregions.

3. The method of claim 2, wherein obtaining the prediction mode of each of the chroma subregions comprises:
decoding from a bitstream a flag indicative of whether a cross-component-based prediction is to be performed; and
checking the flag,
wherein the method further comprises, when the flag is true:
determining the prediction mode of each chroma subregion by the cross-component-based prediction.

4. The method of claim 3, wherein obtaining the prediction mode of each of the chroma subregions comprises, when the flag is false:
decoding the prediction mode of each of the chroma subregions,
wherein the prediction mode of each of the chroma subregions is one of vertical, horizontal, DC, and planar modes, a direct mode (DM), and a prediction mode derived by using neighboring reconstructed samples of the current chroma block.

5. The method of claim 4, wherein obtaining the prediction mode of each of the chroma subregions comprises, when a decoded mode is the DM:
determining the prediction mode of each of the chroma subregions to be a prediction mode of a luma subregion corresponding to each of the chroma subregions.

6. The method of claim 2, wherein obtaining the prediction mode of each of the chroma subregions comprises:
determining whether a cross-component-based prediction is to be enabled based on a count of chroma reference samples used for the prediction of each of the chroma subregions,
wherein the method further comprises, when the cross-component-based prediction is enabled:
determining the prediction mode of each of the chroma subregions by the cross-component-based prediction.

7. The method of claim 1, wherein obtaining the prediction mode of the current chroma block comprises, when the block partition structures of the luma component and the chroma component are different, and when the corresponding luma region comprises a block that is predicted according to the spatial geometric partitioning mode:
partitioning the current chroma block into chroma subregions by using a color format of a current picture and a geometric partitioning mode of the block predicted according to the spatial geometric partitioning mode; and
obtaining a prediction mode of each of the chroma subregions.

8. The method of claim 1, wherein obtaining the prediction mode of the current chroma block comprises, when the block partition structures of the luma component and the chroma component are different, and when the corresponding luma region is partitioned into a plurality of blocks:
partitioning the current chroma block into chroma subregions by using a color format of a current picture and partitioning information of the corresponding luma region; and
obtaining a prediction mode of each of the chroma subregions.

9. The method of claim 3, wherein generating the prediction block of the current chroma block comprises, when the prediction mode of each of the chroma subregions is the cross-component-based prediction:
calculating parameters representing a linear relationship between the luma component and the chroma component by using samples in a reconstructed region of the luma component and the chroma component; and
generating, based on the parameters, a prediction block of each of the chroma subregions from samples in the corresponding luma region.

10. The method of claim 2, wherein generating the prediction block of the current chroma block comprises, when the current chroma block includes two subregions:
generating initial prediction blocks of the two subregions, respectively; and
weight summing the initial prediction blocks of the two subregions by using a blending matrix.

11. A method of encoding a current chroma block by a video encoding device, the method comprising:
establishing a corresponding luma region of the current chroma block from a reconstructed region of a luma component, the corresponding luma region being an intra-predicted region and representing a luma block or a luma region co-located with the current chroma block;
determining a prediction mode of the current chroma block based on whether a spatial geometric partitioning mode is applied to the corresponding luma region, an intra-prediction mode of the corresponding luma region, and block partition structures of the luma component and a chroma component; and
generating a prediction block of the current chroma block based on the prediction mode of the current chroma block.

12. The method of claim 11, wherein determining the prediction mode of the current chroma block comprises, when the block partition structures of the luma component and the chroma component are equal, and when the corresponding luma region is predicted according to the spatial geometric partitioning mode:
partitioning the current chroma block into chroma subregions by using a color format of a current picture and a geometric partitioning mode of the corresponding luma region; and
determining a prediction mode of each of the chroma subregions.

13. The method of claim 12, wherein determining the prediction mode of each of the chroma subregions comprises:
determining the prediction mode of each chroma subregion by the cross-component-based prediction, and
wherein the generating of the prediction block of the current chroma block comprises:
generating a first prediction block of each of the chroma subregions based on the cross-component-based prediction.

14. The method of claim 13, wherein determining the prediction mode of each of the chroma subregions comprises:
determining the prediction mode of each of the chroma subregions to be one of vertical, horizontal, DC, and planar modes, a direct mode (DM), and a prediction mode derived by using neighboring reconstructed samples of the current chroma block, and
wherein the generating of the prediction block of the current chroma block comprises:
generating a second prediction block of each of the chroma subregions according to the prediction mode of each of the chroma subregions.

15. The method of claim 14, further comprising:
determining, for each of the chroma subregions, based on the first prediction block and the second prediction block, a flag indicative of whether the cross-component-based prediction is to be performed; and
encoding the flag.

16. A computer-readable recording medium storing a bitstream generated by a video encoding method, wherein the video encoding method comprises:
establishing a corresponding luma region of a current chroma block from a reconstructed region of a luma component, the corresponding luma region being an intra-predicted region and representing a luma block or a luma region co-located with the current chroma block;
determining a prediction mode of the current chroma block based on whether a spatial geometric partitioning mode is applied to the corresponding luma region, an intra-prediction mode of the corresponding luma region, and block partition structures of the luma component and a chroma component; and
generating a prediction block of the current chroma block based on the prediction mode of the current chroma block.
